(19) United States
(12) Patent Application Publication
(10) Pub. No.: US 2007/0254070 A1
(43) Pub. Date: Nov. 1, 2007

(54) Encapsulating Plant Extracts Adsorbed and/or Absorbed in Precipitated Silica

(75) Inventors: Monique Lombardy epouse Alric, Clermont-Ferrand (FR); Jean-Michel Cardot, Ceyrat (FR); Francois Gautier, Seynod (FR); Christopher Kamel, Miami Playa (ES); Laurence Mazuranok, Bellegarde Sur Valserine (FR); Jean-Philippe Meunier, Cessy (FR)

Correspondence Address: WILLIAM H. EILBERG, THREE BALA PLAZA, SUITE 501 WEST, BALA CYNWYD, PA, 19004, US

(73) Assignee: AXISS FRANCE S.A.S., Bellegarde sur Valserine (FR)

(21) Appl. No.: 11/576,569

(22) PCT Filed: Oct. 5, 2005
(86) PCT No.: PCT/FR05/02441

§ 371 Date: Apr. 3, 2007

(30) Foreign Application Priority Data
Oct. 5, 2004 (FR) 04 10618

(51) Int. Cl. A23K 1/00

(52) U.S. Cl. 426/89

(57) ABSTRACT

A powdery product is based on one or several plant extracts for animal feed or veterinary medicine. The plant extract(s) are in the form of hydrophobic liquid, adsorbed and/or absorbed in spheroid precipitated silica granules of average size ranging between 90 μm and 500 μm approximately. The spheroid precipitated silica granules containing the absorbed plant extract(s) are coated with a layer of protective coating material. The coating is performed by a fluidized airbed process, enabled by the use of the spheroid precipitated silica granules.

### TECHNICAL FIELD OF THE INVENTION

The present invention relates to the plant extracts used as food additives in animal feed or veterinary medicine, for improving animal health and/or zootechnical performance levels.

Products generally used are either natural plant extracts or “identical natural” products. The “identical natural” products are obtained by synthesis and have a molecular structure identical to that of natural extracts.

In the description of the present patent application, and in the claims, the expression “plant extracts” will denote without distinction natural plant extracts and identical natural products, and the expression “hydrophobic liquid” will denote a liquid that is water-insoluble or relatively water-insoluble, i.e. the solubility of which is less than ten grams per liter of water.

A large number of these plant extracts come from the separation of one or more liquid or solid constituents derived from a starting material by vapor entrainment or dissolution in a fluid, are essential oils, resins, oleoresins or aromas, and exist in liquid or even pasty form. The often lipophilic nature of these constituents also makes them water-insoluble or relatively water-insoluble.

These plant extracts are used in small amount, and must be mixed with a feed substrate, for administration to animals.

When the plant extract is in liquid form, it is often difficult to disperse homogeneously in the feed substrate. It is for this reason that a plant extract in powdered form, in which the plant extract is attached to a substrate, is preferred. However, its conservation can only be ensured for a relatively short period of time, since prolonged storage for a few months, or even a few weeks, leads to a loss of its properties that are often associated with very volatile, hygroscopic or oxidation-sensitive components.

In the plant extracts used, a certain number of molecules may be toxic or irritant to the handler, may pose the feed problems of taste and odor that make it less appetizing, may be incompatible with a coingredient used in the premixes or in the feed, and may be sensitive to the various processes for manufacturing the feed, for example during steam granulation or during extrusion.

For a certain number of applications, the action of plant extracts can be significantly optimized by means of a system of protection which makes it possible to target a given release site.

For the above reasons, various techniques for encapsulating pulverulent plant extracts have been developed over a number of years. Techniques for spray drying, spray cooling, extrusion, granulation, adsorption and/or absorption onto a carrier (silica, salt, middlings, corn cobs, maltodextrins) or fluidized airbed coating have thus been proposed.

However, the prior art generally accepted demonstrates the difficulty in using the fluidized airbed technique industrially for coating a pulverulent product based on one or more plant extracts for animal feed or veterinary medicine, especially in the case of hydrophobic plant extracts.

In particular, coating by the fluidized airbed technique appears to be inapplicable for protecting the plant extracts that exist in the form of a hydrophobic liquid. Indeed, in this case, it is difficult to find a suitable carrier in order to attach the liquid to a solid before a coating step, without resorting to a prior and expensive granulation step. The degree of absorption of the liquid onto the solid generally remains low, less than 30% by weight, and the carrier generally used requires coating thicknesses that are too great and make the process industrially inapplicable for use in animal feed or in veterinary medicine.

These difficulties have, up until now, resulted in techniques for spray drying, spray cooling, extrusion, granulation or adsorption and/or absorption onto a carrier being preferred. However, spray drying and spray cooling lead to the production of powders that are too fine and do not meet the requirements for safe use. Extrusion does not make it possible, either, to obtain a powder that has the desired physical properties for ensuring homogeneous mixing in a feed substrate.

In these techniques, the plant extracts in liquid form are incorporated into a matrix in order to facilitate their use, but the protection is not complete. There is generally no outer coating layer that provides complete protection of the active ingredient with respect to the surrounding environment. It will therefore be difficult to envision, for example, the use of these techniques when the objective is to have control of the release of the active ingredient in the digestive tract.

Document WO 2004/073689 A1 describes and claims tablets or gelatin capsules obtained by agglomeration of silica particles containing a hydrophobic active ingredient in solution in an oil. The particles are small in size, between 2 μm and 400 μm, preferably between 20 μm and 30 μm, in order to ensure good agglomeration. The agglomerates can be formed in a fluidized bed, and then optionally coated. These tablets provide a better bioavailability of the active ingredient administered orally.

Documents US 2003/0003040 A1, WO 99/07237 A and EP 0 345 109 A1 describe techniques for manufacturing precipitated silicas that have good capacities for absorbing polar compounds.

Document GB 1 125 882 A describes the use of another substrate, namely a dried and ground paste of magnesium and aluminum silicate, for the preparation of medicaments in the form of granules that are subsequently coated.

Document EP 1 132 009 A describes the use of another substrate, namely a magnesium or aluminum silicate hydrate, that is passed through a mixer so as to absorb an active ingredient derived from plants in order to produce an additive for animal feed.

### SUMMARY OF THE INVENTION

The problem stated by the present invention is that of designing a new structure of pulverulent products based on one or more plant extracts for animal feed or veterinary medicine, that makes it possible:
to preserve the integrity of the active ingredient(s) with respect to the environment for a prolonged storage period,
to protect the active ingredient(s) during their incorporation into the feed,
to protect the environment against the potential toxicity of the active ingredient(s),
to preserve the taste and smell of the feeds, ensuring that they are appetizing and preventing them from being made irritant in nature,
to provide the pulverulent products with good flowability, very low or even zero dusting, a high density, a high concentration of active ingredients,
to control the release of the active ingredient(s) in the digestive tract.

The invention is simultaneously directed toward improving the effectiveness of plant extracts on animals, for improving animal health and/or zootechnical performance levels.

To achieve these aims, and others, the invention provides a pulverulent product based on one or more plant extracts for animal feed or veterinary medicine, in which:
the plant extract(s) is (are) in the form of a hydrophobic liquid,
the plant extract(s) is (are) adsorbed and/or absorbed in precipitated silica,
the precipitated silica is in the form of non-agglomerated spheroidal granules,
the spheroidal granules of precipitated silica have a size of between approximately 90 μm and 500 μm, preferably between approximately 200 μm and 500 μm, substantially devoid of fine particles, i.e. of particles that have a size of less than approximately 90 μm,
the spheroidal granules of precipitated silica containing the adsorbed and/or absorbed plant extract(s) are coated with a layer of protective coating material.

The nature and the specific morphology of the substrate used make it possible to produce, industrially and at low cost, an effective and nondisruptive protective coating, so as to solve the above problem.

Better coating and fluidity results will be obtained, in the case of an industrial production, by using spheroidal granules of precipitated silica of between approximately 200 μm and 500 μm in size. The risks of agglomeration during the production of the coating and the subsequent risks of deficient coating and protection are in particular avoided. In fact, agglomerates of spheroidal particles have a random non-spheroidal shape which is less suitable for the production of a continuous coating, and have a random size. Such agglomerates are thus not capable of solving the problem which forms the basis of the invention.

Preferably, the plant extract(s) in liquid form is (are) present in the precipitated silica according to a proportion of greater than 20% by weight, preferably a proportion of greater than 30% by weight. The coating quality and efficiency are thus improved, while at the same time the effectiveness of the product itself is optimized.

Good results are obtained by providing for the spheroidal granules of precipitated silica to have a fill density in the packed state DRT of greater than 0.29, a DOP oil uptake of greater than 100 milliliters/100 grams, a BET surface area of between approximately 140 and 240 m²/gram, a CTAB specific surface area of between approximately 140 and 230 m²/gram, a water content of less than 5% by weight, and a screen oversize rate of at least 92% by weight for mesh apertures of 75 μm.

In order to perform effective protection, the protective coating material is preferably present in a proportion of approximately 10% to 30% by weight of the pulverulent product.

The protective coating material will be chosen according to the applications envisioned. For example, the protective coating material can provide masking of the taste or of the irritant effects of the active ingredients contained in the plant extract(s). According to another example, the protective coating material can ensure the stability of the active ingredients contained in the plant extract(s) over a period of storage and/or during industrial processes for use of the product, in particular for the manufacture of feeds.

According to an advantageous possibility, the protective coating material can have the property of dissolving in a medium whose pH is greater than a given threshold pH, so as, for example, to be gastro-resistant. More generally, the protective coating material can be chosen so as to provide accelerated, delayed or targeted release, in the digestive tract, of the active ingredients contained in the plant extracts.

A protective coating material chosen from the coating agents used in pharmaceuticals or agrofoods can, for example, be used.

Good results have been obtained by using an aqueous hydroxypropylmethylcellulose (HPMC)-based protective coating material.

The protective coating material may, for example, be based on gum, or on polysaccharides (starch, cellulose), or on protein, or on methacrylic acid copolymers, or on fats, or on a mixture of these products.

According to an advantageous possibility, the protective coating material can have the property of controlling the site of release of the active ingredients during digestion. Good results have been obtained for this by using a protective coating material based on a suspension of ethylcellulose (EC).

As an alternative, a protective coating material based on any type of coating material conventionally used, such as: fat, gum, starch, protein, etc., and mixtures thereof, can be used.

Good results have been obtained by carrying out the coating using a fluidized airbed technique. In this case, the layer of protective coating material has the physicochemical properties of a layer produced by a fluidized airbed: homogeneity of the coating, continuity of the coating.

The plant extract(s) can be initially in the form of a hydrophobic liquid such as an essential oil, oleoresin, gum, resin or aroma.

The invention also provides a process for the manufacture of a pulverulent product according to the above characteristics, the process comprising the following steps:
a) providing spheroidal granules of precipitated silica with an average size of between approximately 90 μm and 500 μm, preferably between approximately 200 μm and 500 μm, substantially devoid of fine particles,
b) providing one or more plant extracts in the form of a hydrophobic liquid,
c) carrying out the adsorption and/or the absorption of a suitable amount of the hydrophobic liquid in the spheroidal granules of precipitated silica, while at the same time preventing agglomeration of said granules,
d) applying at least one layer of protective coating material to the nonagglomerated spheroidal granules of precipitated silica containing the hydrophobic liquid.

The adsorption and/or absorption step c) can advantageously be carried out by spraying in a fluidized airbed or in a mixer.

During this adsorption and/or absorption step, it is advantageous for the hydrophobic liquid to be adsorbed and/or absorbed in the precipitated silica according to an amount of at least 20% by weight, preferably of at least 30% by weight. In this way, a powder of sufficient density is obtained, which is then compatible with the subsequent fluidized airbed coating technique. This improves the quality and the efficiency of the coating.

During step d), the coating of the spheroidal granules can advantageously be carried out by spraying the liquid protective coating material onto the spheroidal granules in a fluidized airbed.

During this coating step, the liquid protective coating material can advantageously be an aqueous solution, an aqueous emulsion or a fat (lipid).

In order for the coating step to be carried out rapidly and inexpensively, it is advantageous, in the case of a protective coating material in an aqueous solution or in an aqueous emulsion, for the concentration of coating excipient to be from 8% to 30% by weight, and preferably from 10% to 25% by weight.

It is also advantageously possible to provide for the presence, in the protective coating material, of a plasticizer in a proportion of from 5% to 40% by weight of material.

The invention also provides for the application of such a product to animal feed, in which application a small amount of the pulverulent product is introduced into a feed substrate. If necessary, mixing/dispersing is carried out in order to equally distribute the pulverulent product in the feed substrate. The effectiveness of the plant extract on the animal is thus substantially improved.

The invention can, however, be applied by depositing the additive on the feed. In this case, there is no homogeneous mixing.

### BRIEF DESCRIPTION OF THE DRAWINGS

Other subjects, characteristics and advantages of the present invention will emerge from the following description of specific embodiments, given in relation to the attached figures, among which:

FIG. 1 is a sectional view across the diameter, illustrating the structure of a grain of powder of the product according to one embodiment of the present invention;

FIG. 2 illustrates the essential steps for the manufacture of the pulverulent product according to the invention;

FIGS. 3 to 5 illustrate schematically three embodiments of a fluidized airbed technique that can be used according to the invention; and

FIG. 6 is a schematic view of a fluidized airbed treatment plant that can be used according to the invention.

### DESCRIPTION OF THE PREFERRED EMBODIMENTS

For several years, many properties of plant extracts have been demonstrated for improving animal health or zootechnical performance levels. For example, it has been possible to establish the action of plant extracts such as essential oils on bacteria. This action may be bactericidal and/or bacteriostatic. Mention may, for example, be made of the bactericidal action of carvacrol, which is the main component of oregano essential oil.

At low concentrations, these plant extracts have shown an antioxidant action or stimulatory action on the activity of certain specific bacterial populations. This phenomenon has been demonstrated in laboratory animals through the stimulation of lactic acid production by lactobacilli in the presence of oregano essential oil.

The table below gives a list of the effects of many active ingredients extracted from plants.

| Active | Plants of | |
|---|---|---|
| ingredients | origin | Properties |
| Phenols | | Anti-infective (broad spectrum: |
| | | bactericidal, virucidal, fungi- |
| | | cidal, parasiticidal), immuno- |
| | | stimulator, tonic, general |
| | | stimulant and central nervous |
| | | system stimulant. |
| Carvacrol | Oregano | + spasmolytic, anti-inflammatory, |
| | | antioxidant, free-radical |
| | | scavenger, antiseptic, |
| | | expectorant. |
| Thymol | Thyme | + analgesic, sedative, |
| | | gastrointestinal stimulator, |
| | | anti-inflammatory, antioxidant, |
| | | free-radical scavenger, |
| | | antiseptic. |
| Eugenol | Clove | + spasmolytic, carminative, anti- |
| | | inflammatory, antioxidant, free- |
| | | radical scavenger, antiseptic, |
| | | antispasmodic, anticonvulsant, |
| | | hepatoprotective, choleretic. |
| Monoterpenols | | Anti-infective (broad spectrum), |
| | | general stimulant and |
| | | immunostimulant |
| Linalol | Rose wood | + sedative, spasmolytic. |
| Menthol | Mint | + hepatostimulant, vaso- |
| | | constrictor, analgesic, |
| | | gastrointestinal stimulator, |
| | | anti-inflammatory, carminative, |
| | | antiseptic, antispasmodic, |
| | | expectorant, enterorelaxant, |
| | | carminative. |
| Aromatic | | Major anti-infective, general |
| aldehyde | | tonic and sympathetic nervous |
| | | system tonic. |
| Cinnamaldehyde | Cinnamon | + anti-inflammatory, antioxidant, |
| | | free-radical scavenger, |
| | | antiseptic, spasmolytic, gastro- |
| | | intestinal stimulator, |
| | | choleretic. |
| Oxides | | Anti-infective, immunomodulator. |
| Cineol | Eucalyptus | + choleretic, spasmolytic, |
| | | antiseptic, central nervous |
| | | system stimulant, sedative. |
| Phenol methyl | | Analgesic, anti-inflammatory, |
| ether | | gastrointestinal stimulator, |
| | | antiseptic, spasmolytic, tonic, |
| | | analgesic, toning, antibacterial |
| | | and antiviral. |
| Trans-anethole | Anise | + carminative, gastrointestinal |
| | | stimulator |
| Estragole | Basil | + gastrointestinal stimulator |
| Ether oxides | | Analgesic, gastrointestinal |
| | | stimulator, antiseptic, |
| | | spasmolytic, tonic. |
| Apiole | Parsley | + vasodilatory. |
| Sulfur | | Gastrointestinal stimulator, |
| compound | | cholesterolytic, anti- |
| | | inflammatory. |
| Allicin | Garlic | |
| Alkaloids | | Action on the central nervous |
| | | system, anesthetic. |
| Sanguinarine | Bloodroot | Antimicrobial, antifungal, anti- |
| | | inflammatory. |
| Saponosides | | Molluscicide, antitussive, |
| | | diuretic, anti-inflammatory. |
| Glycyrrhizin | Liquorice | + anti-diarrhea agent, gastro- |
| | | intestinal stimulator, anti- |
| | | inflammatory, antioxidant, |
| | | immunostimulant. |

Thus, the plant extract constitutes the first essential element incorporated into the product according to the invention.

The plant extracts used by the invention are most commonly in the form of hydrophobic liquids. They may be natural extracts or “identical natural” synthetic products.

They may be in the form of essential oils, resins, oleoresins or aromas.

The second essential element that is part of the composition of the product according to the invention is a substrate in the form of spheroidal granules of suitable size.

The difficulty has been in finding a substrate which at the same time is capable of containing a sufficient amount of plant extracts, is compatible with the production of an effective protective coating, and has good properties of active ingredient release after administration to the animal.

For this, spheroidal granules of precipitated silica are used.

The plant extracts are adsorbed and/or absorbed in the spheroidal granules of precipitated silica.

It has been possible to determine that the size of the spheroidal granules should be within given limits so as to obtain the desired effects.

Thus, it is important for the size of the spheroidal granules to be less than approximately 500 μm, in order to ensure satisfactory homogeneity of the subsequent mixture produced between the pulverulent product and a feed substrate for the animal.

It is important, furthermore, for the size of the spheroidal granules to be greater than 90 μm, in order to avoid the presence of particles that are too fine: such particles that are too fine could result, firstly, in the presence of particles in suspension in the air when the product is used, which would be harmful for the handlers; these particles that are too fine would, secondly, result in a substantial disruption of the coating process in a fluidized airbed, due to the formation of agglomerates. A size greater than approximately 200 μm gives better results, by virtue of a greater coating reliability.

It is subsequently advantageous to choose spheroidal granules of precipitated silica that have a fill density in the packed state (DRT) of greater than 0.29. The fill density in the packed state can be determined according to standard NF T 30-042.

It is also advantageous to choose a precipitated silica which allows a DOP hydrophobic oil uptake of greater than 100 milliliters/100 grams. The DOP hydrophobic liquid uptake can be measured according to standard NF T 30-022 (March 1953) using dioctylphthalate.

The porous volumes of the precipitated silica can also be advantageously characterized. The porous volumes are measured by mercury porosimetry. For this, the preparation of each sample can be carried out as follows: each sample is predried for two hours in an oven at 200° C. and then placed in a test vessel within five minutes following removal from the oven, and then vacuum-degassed, for example using a rotary vane pump. The pore diameters are calculated by the Washburn equation with a contact angle θ equal to 140° C. and a surface tension γ equal to 484 dynes/cm. A porosimeter of the trademark MICAOMERITICS 9300 can be used.

The precipitated silica can also be characterized by its BET specific surface area, which will be chosen at between approximately 140 and 240 m²/g. The BET specific surface area is determined according to the method of BRUNAUER-EMMET-TELLER described in—The journal of the American Chemical Society—vol. 60, page 309, February 1938, and corresponding to standard NF T 45007 of November 1987.

The precipitated silica can also be characterized by its CTAB specific surface area, which will be chosen at between approximately 140 and 230 m²/g. The CTAB specific surface area is determined according to standard 10 NF R 45007 of November 1987.

Care will also be taken to ensure that there are no, or a very low proportion of, fine particles by providing spheroidal particles, the oversize rate of which is at least 92% by weight in a screen having a mesh aperture of 75 μm.

In order to optimize its ability to adsorb and/or absorb plant extracts, the precipitated silica will preferably have a low water content: its water content (loss when dried at 105° C. for 2 hours) will preferably be less than 5% by weight, before absorption of the plant extracts.

A precipitated silica having an average friability below an acceptable limit may also be sought. The friability of the precipitated silica is measured according to the following method: a test sample that has been exactly weighed out and is equal to 800 grams of precipitated silica, having a defined particle size, for example from 90 μm to 350 μm, is introduced into a fluidized airbed device, for example a device of the trademark Glatt GPCG1; the silica is then subjected to a fluidized airbed with an air entry of 100 m³/hour, at a temperature of 25° C. and an air pressure of 2.5 bar for 30 minutes. Next, the sample is again screened on a 90 μm screen, and then weighed. The friability F (percent) is given by the expression:
F=(1−B/A)100%
with A=weight of the silica retained by the 90 μm screen before test
with B=weight of the silica retained by the 90 μm screen after test.

The precipitated silica may also be characterized by its flowability. The flowability is illustrated by the flow time of conditioned compositions, and is measured by passing 50 grams of product through a glass silo with a calibrated orifice (cylinder diameter: 50 mm; cylinder height: 64 mm; cone angle: 53°; passthrough diameter at the base of the cone: 8 mm). According to this method, the silo, closed at its base, is filled with 50 grams of product; the base is then opened and the time taken for the 50 grams of the product to completely flow through is noted.

The flowability can also be assessed by measuring the talus angle according to standard NF T 20-221.

The third essential element that goes to make up the composition of the pulverulent product according to the invention is the protective coating. The protective coating has the function of isolating the plant extracts in relation to the ambient medium, for the entire preliminary period during which it is desired to avoid contact with the plant extracts.

When the objective of the coating is, for example, to protect the active ingredient against the environment for a prolonged storage period, cellulose-based polymers, fats, starch derivatives or gum can be used.

The protective coating material can also perform the role of masking the taste or the irritant effects of the active ingredients contained in the plant extract(s). Good results have, for example, been obtained with an aqueous hydroxypropylmethylcellulose (HPMC)-based protective coating material.

When the objective of the coating is to accelerate/delay or target the release of the active ingredients in the gastrointestinal tract, the choice of the polymer will depend on the animal species under consideration, and on the desired objective (gastro-resistance, colic release, ruminal or postruminal release). For an application in monogastric animals, pH-sensitive (or pH-dependent) polymers can, for example, be used. A large variety of such pH-sensitive polymers is available. They differ from one another by virtue of the pH at which they start to dissolve. Examples of materials that can be used are available under the trademarks:
EUDRAGIT®
AQUATERIC®
AQOAT®.

Blends of compatible polymers can be envisaged for obtaining dissolutions at intermediate pHs.

The dissolution pH thresholds are in practice affected by the choice of plasticizers or of colored pigments, incorporated into the polymers, by the thickness of the coating, and by the formulation of the cores and the disintegration forces.

However, for reasons of cost or regulatory reasons, other excipients (cellulose, waxes, fats, etc.), which can delay the release of the active ingredient in the gastrointestinal environment, for example in monogastric animals such as dogs or pigs, may be preferred.

The percentage of coating to be used depends on the nature of the excipient, on the desired objective (gastroresistance, colic release, etc.) and on the size of the particles to be coated.

In practice, the amount of coating represents a percentage of 10% to 30% by weight for particles of spheroidal silica having a size of between 90 μm and 500 μm. An efficient action is then obtained.

A plasticizer is often required in the coating composition in order to ensure that the film has good plasticity. The type of plasticizer used will depend on the selection of the coating excipient. An excipient can be used according to a proportion of from 5% to 40%, according to the recommendations of the excipient manufacturers.

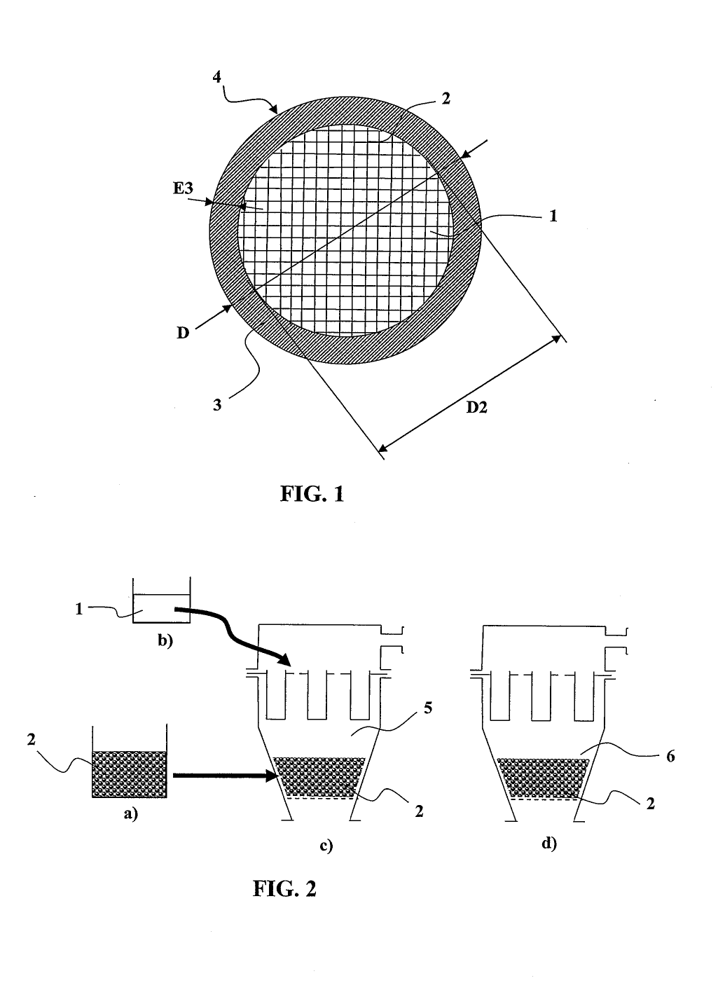

The pulverulent product according to the invention is illustrated in FIG. 1, representing a section across the diameter of a grain of pulverulent product according to the invention. Plant extracts in the form of a hydrophobic liquid adsorbed and/or absorbed in a spheroidal granule of precipitated silica 2, the average diameter D2 of which is between approximately 90 μm and 500 μm, and a layer of protective coating material 3 having a thickness E3 and the outer surface 4 of which defines the overall diameter D of the grain of powder, are distinguished on this section.

The plant extracts 1 in liquid form are present in the precipitated silica 2 according to a proportion greater than 20% by weight.

The thickness E3 of the coating material is chosen in such a way that the protective coating material 3 is present in a proportion of approximately 10% to 30% by weight of the pulverulent product.

Reference is now made to FIG. 2, which illustrates the main steps of the process for manufacturing a pulverulent product according to FIG. 1.

According to step a), spheroidal granules of precipitated silica 2 that have an average size of between approximately 90 μm and 500 μm are provided.

This silica can be prepared by means of a process of the type comprising the reaction of a silicate with an acidifying agent so as to obtain a suspension of precipitated silica, and then the separation and drying of this suspension using a spray nozzle device. A process as described in document WO 99/07237 may, for example, be used. Other processes may be envisioned.

In step b), one or more plant extracts in the form of a liquid 1 that is generally hydrophobic is (are) provided.

During step c), the adsorption and/or the absorption of a suitable amount of the hydrophobic liquid 1 in the spheroidal granules of precipitated silica 2 is carried out.

The adsorption and/or the absorption of the liquid 1 onto the carrier based on said precipitated silica 2 can be carried out by spraying, directly in a fluidized airbed 5.

As an alternative, more conventionally, the adsorption and/or the absorption can be carried out in a mixer.

The amount of the liquid 1 adsorbed and/or absorbed depends in general on the desired application. However, in particular in the case of an essential oil, the content of liquid will have to be at least 20% by weight, more advantageously greater than 30%, in order to obtain particles of sufficient density to allow the subsequent coating during step d).

During step d), at least one layer of protective coating material 3 is applied to the spheroidal granules of precipitated silica 2 containing the hydrophobic liquid 1. The coating can advantageously be carried out, according to the invention, by spraying the protective coating material onto the spheroidal granules 2 in a fluidized airbed 6.

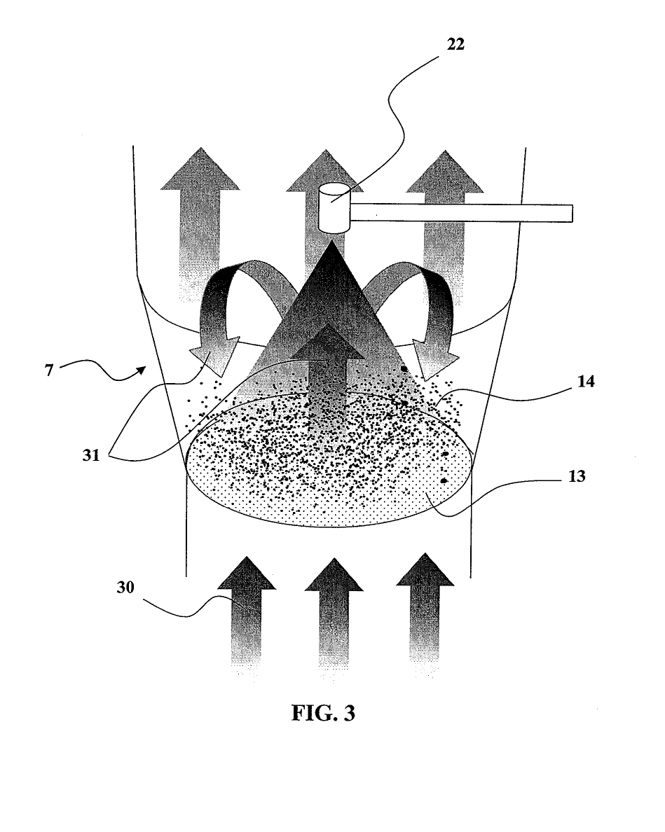

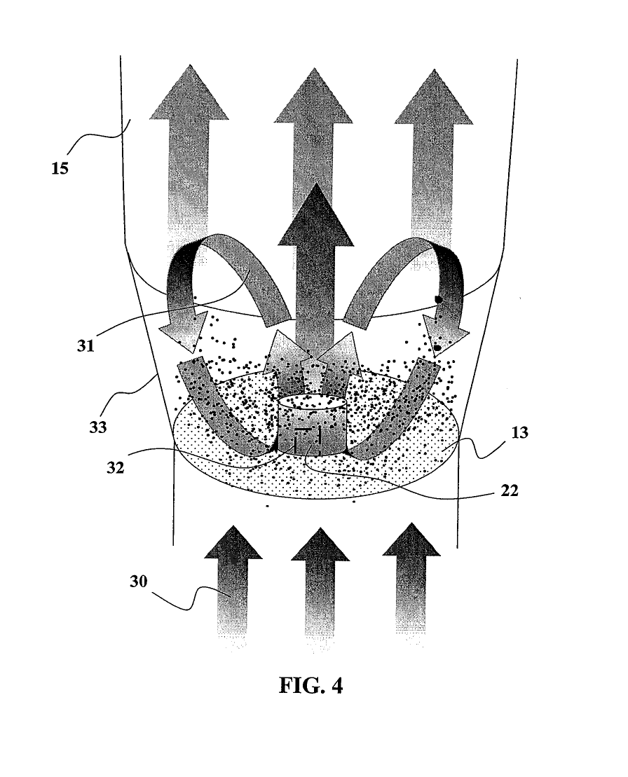

Reference is now made to FIGS. 3, 4, 5 and 6, for the explanation of the fluidized airbed technique.

The principle of the fluidized airbed is based on the creation of an ascending suspending airflow by means of a suction phenomenon. This ascending airflow, the pressure and temperature of which are fixed according to predefined parameters, is channeled so as to cross, from bottom to top, a bed of pulverulent material and to bring about the suspension of said material.

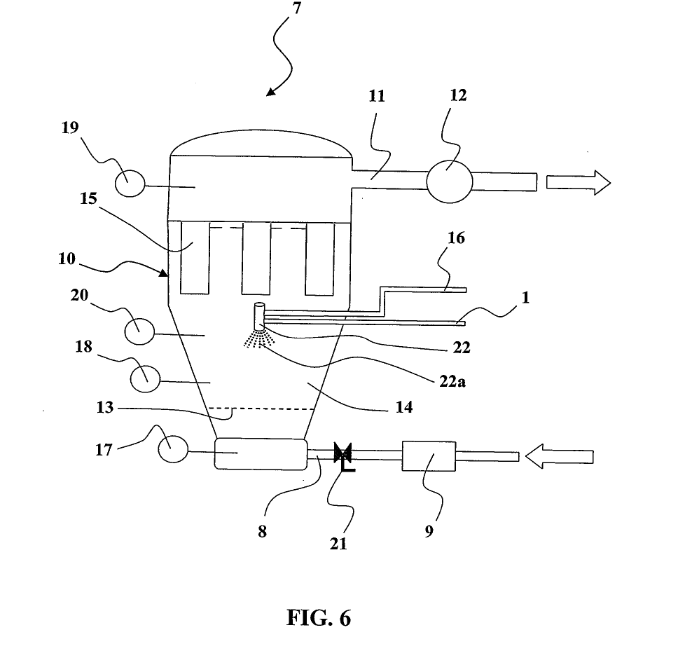

The following are distinguished on the fluidized airbed system 7 according to FIG. 6: a suspending air inlet 8 with a filtration and heating system 9, that allows hot suspending air to enter at the base of a chamber 10 that has an upper air outlet 11 connected to the atmosphere via a suction device 12. A distribution screen 13, in the lower zone of the chamber 10, limits the base of a zone of fluidized pulverulent products 14, or spray zone. Above the spray zone 14, there is a filtration zone 15, upstream of the outlet 11 in the direction of flow of the suspending air.

Means for spraying liquid are provided in the device for spraying the liquid in the spray zone 14 In the implementation illustrated in FIG. 6, it is a top spray. The spraying is carried out by injection of liquid 1 and of spraying air 16.

The suspending air inlet temperature is controlled by lower temperature control means 17, the temperature in the spray zone 14 by intermediate temperature control means 18, the temperature in the upper zone by upper temperature control means 19, and the humidity in the spray zone 14 is controlled by moisture sensors 20. The amount of suspending air admitted is controlled by an air inlet valve 21.

The spray nozzle 22 is placed above the particles in suspension in the airbed of the spray zone 14, and the spraying 22a of the wetting agent is carried out from top to bottom.

The device is thus made up of two sections in contact with the product:
a chamber 10 that is advantageously in the form of a conical tank, equipped with a perforated bottom or screen 13 for retaining the product to be treated, and equipped with the spray nozzle 22 directed downward, that can be positioned at two levels in the tank depending on the amount of product treated;
an upper extension which forms the housing of a sleeve filter, constituting the filtration zone 15 which makes it possible to retain the product being treated so as to prevent it escaping via the upper air outlet 11.

Periodically, during the process, the fluidization stops and the filter is unclogged by mechanical shaking which allows the fine particles to return to the airbed for coating.

FIG. 3 illustrates once again, in partial perspective, the system 7 of FIG. 6, by representing the suspending air flow 30 and the flow of the particles 31 in the spray zone 14.

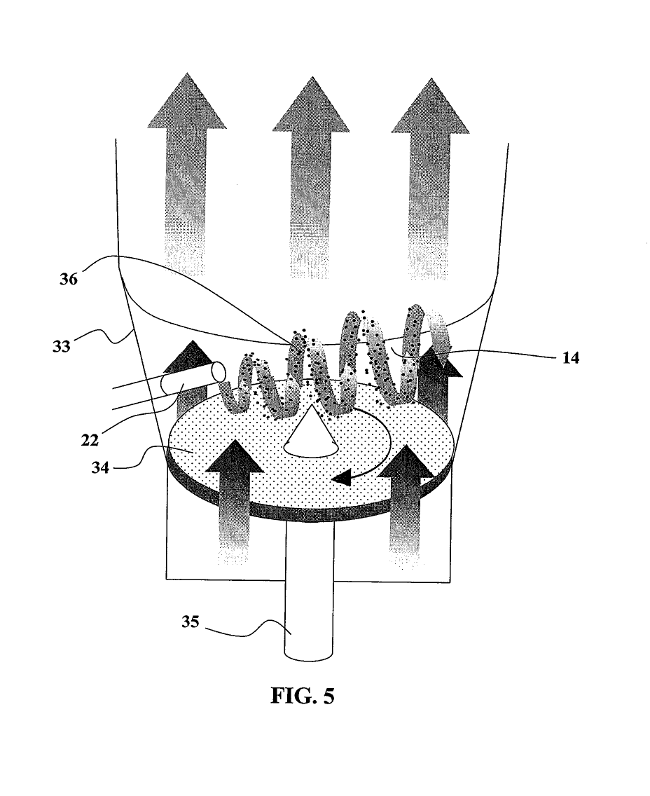

FIG. 4 illustrates a bottom spray coating system. The spray nozzle 22 is placed at the bottom of the tank, at the center of the perforated plate or screen 13, and is surmounted by a cylinder 32. The spraying of the wetting liquid or of the coating agent is carried out from bottom to top. The device is made up of a conically shaped WÜRSTER-type removable tank 33 that fits onto the housing of the sleeve filter 15 of the device. The tank 33 comprises a perforated tank bottom plate 13, a cylinder 32 (optional) located in the lower part of the tank above the perforated plate, and the height of which can be adjustable, and a nozzle 22 located at the center of the perforated plate 13, under the cylinder 32, and directed for spraying from bottom to top. The greater volume of air that crosses the center of the perforated plate 13 and the internal cylinder 32 create, as a result, an ascending stream 31 of material which then redescends toward the outside, giving the suspended particles a “fountain-like” movement. The suspended material circulates rapidly in this manner and, each time the product passes close to the spray nozzle, it receives an additional layer of coating. When the spraying of the coating liquid has stopped, it is followed by drying, which continues in the same tank with simply an increase in the temperature and in the flow rate of the entering air 30. A very even surface of the coating is thus obtained.

FIG. 5 illustrates a tangential spray coating system. For this particular application, the device consists of a conically shaped product tank 33, equipped at its base with a metal disk 34 mounted so that it can rotate around a vertical axis 35, the speed of which can be modulated. The vertical position of the disk can be modified upward or downward, creating a more or less large opening between the disk 34 and the product tank 33. The preconditioned air is suctioned through this more or less large opening between the disk 34 and the tank 33. This air produces the fluidization of the particles to be coated in the region of the circumference of the product tank 33. Simultaneously, the disk 34 rotates at a certain speed and the centrifugal force generated causes displacement of the particles toward the walls of the product tank 33, where they are raised by the fluidizing air current to the expansion chamber 14. The particles are then slowed down and redescend by gravity to the center of the disk, and repeat the movement cyclically. The combination of the centrifugal force, of the ascending force from the fluidizing air and of the gravitational force produces a spiraling helicoidal movement 36. The cycle is very rapid and the mixing effect is very great. The spray nozzle 22 is immersed in the bed of fluidized product, and the coating liquid is applied tangentially with respect to the particle flow.

It is important, according to the invention, to carry out an effective coating that ensures effective protection of the plant extracts with respect to the ambient medium. For this, the coating layer 3 must be continuous and sufficiently thick over the entire outer surface of the powder grain as illustrated in FIG. 1. It is possible to obtain such a protection because of the spheroidal form of the granules of silica 2, since the protective coating material is therefore distributed evenly over the entire surface of the granular silica 2, ensuring a relatively constant thickness E3. Simultaneously, the amount of hydrophobic liquid 1 contained in the silica ensures a sufficiently high density, preventing excessive displacement of the granules in the fluidized airbed during coating, such that the coating is carried out satisfactorily.

In addition, the coating is satisfactory by virtue of the absence of particles that are too fine in the fluidized airbed.

It was possible to evaluate the effectiveness of the coating by investigating whether there was any limitation of an irritant effect of certain molecules. Microencapsulated molecules according to the invention were applied to the skin of animals, on a normal zone and on a scarified zone. After defined time periods, the degree of irritation was recorded. The test was carried out over a sufficient period of several days, so as to assess the reversibility of the effects observed.

It was thus possible to observe a very substantial reduction in the irritation reactions due to the use of the pulverulent product according to the invention.

It was subsequently possible to verify the rate of dissolution of the active ingredient from the coated form of the plant extract-based pulverulent products according to the invention. A satisfactory rate of dissolution was thus observed.

A first example of the manufacture of a product according to the invention, consisting of the adsorption and/or the absorption of eugenol and of cinnamaldehyde onto a carrier made of precipitated silica is given hereinafter. In this example, the eugenol and the cinnamaldehyde are synthetic products, chemically identical to the active ingredients contained in extracts of essential oils of clove and of cinnamon.

The products were placed on the carrier in a laboratory mixer of the mark VRIECO-NAUTA 020-FFC-50, rotating at 7 rpm, with an internal axis rotating at 210 rpm, equipped with a spray nozzle through which the liquid mixture is sprayed. The mixer was loaded with 5 kilograms of precipitated silica and then 5 kilograms of the solution of eugenol at 62% and of cinnamaldehyde at 38% were sprayed onto the silica, at ambient temperature and at a flow rate of 75 milliliters/minute. Mixing was performed throughout the process, followed by homogenization for a further 15 minutes. The conditioned composition thus obtained contained 50% by weight of precipitated silica and 50% of the eugenol and cinnamaldehyde mixture. It could be observed that this composition had the properties necessary for a fluidized airbed coating process.

The coating of this composition was carried out in a fluidized airbed (Aeromatic Fieder MP1). The spraying was carried out using a top spray system. The coating product was an aqueous hydroxypropylmethylcellulose (HPMC)-based product, available on the market under the trademark Pharmacoat 603, and applied to the silica according to the process hereinafter. The coating solution was prepared in the form of a mixture of HPMC (18%) and polyethylglycol 6 000 (2%), prepared in water with vigorous stirring until a homogeneous dispersion was obtained, and then left to stand for 24 hours. A mass of 1 000 grams of the conditioned composition based on a silica carrier was placed in the tank of the fluidized airbed, and then a mass of 556 grams of the coating solution was sprayed in order to obtain a coating percentage of 10%. The suspending air flow rate in the coating device was 80 to 90 m³/hour. The temperature of the coating solution was 25° C. The temperature of the product was from 25 to 35° C. The spraying air pressure was 2.5 bar. The spray flow rate was 15 g/minute. The diameter of the nozzle was 1 mm. The drying time after spraying of the coating solution was from 5 to 10 minutes.

A second example of the manufacture of a product according to the invention is given below. The first adsorption and/or absorption step was identical to that of the previous example. The second coating step was carried out in a fluidized airbed using a silica carrier with the Aeromatic Fieder MP1 device. The coating product was an emulsion of ethylcellulose (EC) of the trademark Aquacoat ECD as coating excipient. A solution comprising 614.9 grams of Aquacoat ECD and 45.76 grams of dibutylsebacate, supplemented with 877.3 grams of water, was prepared and then left to stand for 24 hours.

A mass of 800 grams of the conditioned composition based on a silica carrier was placed in a fluidized airbed tank. The air flow rate of the device was fixed at 80-90 m³/h, the temperature of the coating solution was 25° C., the temperature of the product was 25 to 35° C., the spraying air pressure was 2.5 bar, for a spray flow rate of 15 grams/minute and a nozzle diameter of 1 mm. A mass of 200 grams of the coating solution was sprayed in order to obtain a coating percentage of 10%. After spraying of the coating solution, a drying period of from 5 to 10 minutes was observed.

A third example of the manufacture of a product according to the invention is given below. The first adsorption and/or absorption step was identical to that of the previous examples. The second coating step was carried out in a fluidized airbed using a silica carrier with the Aeromatic Fielder MP1 device. The coating product was a hydrogenated rapeseed oil as coating excipient.

A mass of 900 grams of the conditioned composition based on a silica carrier was placed in a fluidized airbed tank. The air flow rate of the device was fixed at 90 m³/h, the temperature of the coating solution was 80° C., the temperature of the product was 37-42° C., the spraying air pressure was 2.5 bar, for a spray flow rate of 18 grams/minute and a nozzle diameter of 1 mm.

A mass of 100 grams of the coating solution was sprayed in order to obtain a coating percentage of 10%. After spraying of the coating solution, a coating-excipient crystallization time of from 5 to 10 minutes was observed.

The present invention is not limited to the embodiments which have been explicitly described, but it includes the diverse variants and generalizations thereof contained in the scope of the claims hereinafter.

1-19. (canceled)

20. Pulverulent product based on one or more plant extracts for animal feed or veterinary medicine, in which:
the plant extract(s) is (are) in the form of a hydrophobic liquid,
the plant extract(s) is (are) adsorbed and/or absorbed in precipitated silica,
wherein:
the precipitated silica is in the form of nonagglomerated spheroidal granules,
the spheroidal granules of precipitated silica have a size of between approximately 90 μm and 500 μm, preferably between approximately 200 μm and 500 μm, substantially devoid of fine particles, and
the spheroidal granules of precipitated silica containing the adsorbed and/or absorbed plant extract(s) are coated with a layer of protective coating material.

21. Product according to claim 20, wherein the plant extract(s) in liquid form is (are) present in the precipitated silica according to a proportion of greater than 20% by weight, preferably a proportion of greater than 30% by weight.

22. Product according to claim 20, wherein the spheroidal granules of precipitated silica have a fill density in the packed state DRT of greater than 0.29, a DOP oil uptake of greater than 100 milliliters/100 grams, a BET surface area of between approximately 140 and 240 m²/gram, a CTAB specific surface area of between approximately 140 and 230 m²/gram, a water content of less than 5% by weight, and a screen oversize rate of at least 92% by weight for mesh apertures of 75 μm.

23. Product according to claim 20, wherein the protective coating material is present in a proportion of approximately 10% to 30% by weight of the pulverulent product.

24. Product according to claim 20, wherein the protective coating material provides masking of the taste or of the irritant effects of the active ingredients contained in the plant extract(s).

25. Product according to claim 20, wherein the protective coating material ensures the stability of the active ingredients contained in the plant extract(s) over a period of storage and/or during industrial processes for use of the product.

26. Product according to claim 20, wherein the protective coating material provides accelerated, delayed or targeted release, in the digestive tract, of the active ingredients contained in the plant extracts.

27. Product according to claim 20, wherein the protective coating material is chosen from the coating agents used in pharmaceuticals or agrofoods.

28. Product according to claim 20, wherein the protective coating material is based on gum, or on polysaccharides (starch, cellulose), or on protein, or on methacrylic acid copolymers, or on fats, or on mixtures thereof.

29. Product according to claim 20, wherein the layer of protective coating material has the physicochemical properties of a layer produced by a fluidized airbed.

30. Product according to claim 20, wherein the plant extract(s) is (are) initially in the form of a hydrophobic liquid such as an essential oil, oleoresin, gum, resin or aroma.

31. Process for the manufacture of a pulverulent product based on one or more plant extracts for animal feed or veterinary medicine comprising the following steps:
a) providing spheroidal granules of precipitated silica with an average size of between approximately 90 μm and 500 μm, preferably between approximately 200 μm and 500 μm, substantially devoid of fine particles,
b) providing one or more plant extracts in the form of a hydrophobic liquid,
c) carrying out the adsorption and/or the absorption of a suitable amount of the hydrophobic liquid in the spheroidal granules of precipitated silica, while at the same time preventing agglomeration of said granules,
d) applying at least one layer of protective coating material to the nonagglomerated spheroidal granules of precipitated silica containing the hydrophobic liquid.

32. Process according to claim 31, wherein the adsorption and/or absorption step c) is carried out by spraying in a fluidized airbed or in a mixer.

33. Process according to claim 31, wherein, during step c), the hydrophobic liquid is adsorbed and/or absorbed in the precipitated silica according to an amount of at least 20% by weight, preferably of at least 30% by weight.

34. Process according to claim 31, wherein, during step d), the coating of the spheroidal granules is carried out by spraying the liquid protective coating material onto the spheroidal granules in a fluidized airbed.

35. Process according to claim 34, wherein, during step d), the liquid protective coating material is an aqueous solution, or an aqueous emulsion, or a fat (lipid).

36. Process according to claim 34, wherein, in the protective coating material in an aqueous emulsion or in an aqueous solution, the concentration of coating excipient is from 8% to 30% by weight, and preferably from 10% to 25% by weight.

37. Process according to claim 34, wherein, the protective coating material contains a plasticizer in a proportion of from 5% to 40% by weight of material.

38. Application of a product according to claim 20 to animal feed, in which a small amount of the pulverulent product is introduced into a feed substrate.
